(19) United States
(12) Patent Application Publication
(10) Pub. No.: US 2009/0297819 A1
(43) Pub. Date: Dec. 3, 2009

(54) Fiber-reinforced resin composition and molded article thereof

(75) Inventors: Koki Yano, Chiba (JP); Rikuo Onishi, Chiba (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: PRIME POLYMER CO., LTD, MINATO-KU (JP)

(21) Appl. No.: 11/597,174

(22) PCT Filed: May 2, 2005
(86) PCT No.: PCT/JP2005/008286

§ 371 Date: Dec. 26, 2006

(30) Foreign Application Priority Data
May 24, 2004 (JP) 2004-153763

(51) Int. Cl. C08K 3/40; B32B 27/04; C08F 267/00

(52) U.S. Cl. 428/297.4; 524/494; 525/301

(57) ABSTRACT

A fiber-reinforced resin composition comprising: (A) a polyolefin-based resin; (B) glass fibers having (B1) an average diameter of 3 to 30 μm and (B2) an average aspect ratio of 50 to 6000; and (C) an acid-modified polypropylene-based resin exhibiting (C1) a change in amount of acid added, measured by Fourier transform infrared spectroscopy, before and after being treated in methyl ethyl ketone at 70° C. for three hours of 0.8 mass % or less, and having (C2) a melt flow rate (load: 2.16 kg, temperature: 230° C.) of 20 to 2000 g/10 min; the composition containing the components (A) to (C) at such a ratio (mass ratio) that (B):[(A)+(C)]=5 to 80:95 to 20 and (A):(C)=0 to 99.5:100 to 0.5.

### TECHNICAL FIELD

The invention relates to a fiber-reinforced resin composition and a molded article produced from the composition.

### BACKGROUND ART

Polypropylene exhibits improved strength in the form of glass fiber-reinforced polypropylene (GFPP) prepared by adding aminosilane-treated glass fibers and carboxylic acid group-containing polypropylene. The strength of long-fiber GFPP prepared using glass fibers with a large aspect ratio is greater than that of short-fiber GFPP. Hence, attention has been paid to the use of long-fiber GFPP for large automobile components. For more effective use for automobile structural components, the long-fiber GFPP is required to exhibit a more improved performance. On the other hand, known carboxylic acid group-containing polypropylene is still used for preparing GFPP. Extensive studies have not yet been made on carboxylic acid group-containing polypropylene which improves the practical performance of long-fiber GFPP used for structural components or the like.

Studies have been made on the molecular weight or the amount added of maleic acid group-containing polypropylene for GFPP. As for by-products formed at the time of producing carboxylic acid group-containing polypropylene, studies have been made on improvement of hue as well as suppression of unfavorable odors, but no attention has been paid to the effect of such by-products on the physical properties (strength) of GFPP.

In Patent Document 1, in order to improve the hue, studies were made on provision of a vent in the production line and performing the production under reduced pressure. However, this method allows removal of only highly volatile by-products, as the pressure reduction time is not long enough. Further, it is difficult to increase the amount added, and production cannot be performed stably (due to occurrence of vent-up problems). In Patent Documents 2, 3, and 4, attempts were made to reduce the amount of unreacted maleic acid by subjecting 1,2-butadiene to graft polymerization prior to polypropylene. However, this method could not suppress formation of by-products.

The above-mentioned studies were made only on short-fiber GFPP with a small aspect ratio. No attention was paid to the physical properties of GFPP with a large aspect ratio and high strength.

In Patent Document 5, studies were made on the effect of maleic acid group-containing polypropylene on the physical properties of long-fiber GFPP. However, attention was paid only to the fluidity and the acid content of the matrix resin, but extensive studies were not made on the effect of low-molecular-weight maleic acid adducts.

### [Patent Document 1] JP-A-7-316239

### [Patent Document 2] JP-A-8-12697

### [Patent Document 3] JP-A-8-134418

### [Patent Document 4] JP-A-8-143739

### [Patent Document 5] JP-A-7-232324

An objective of the invention is to provide a fiber-reinforced resin composition having a high strength and a molded article produced from the composition.

### DISCLOSURE OF THE INVENTION

In view of the above-mentioned problems, the invention was made based on a novel finding that high-strength GFPP containing glass fibers with a large aspect ratio, such as long-fiber GFPP, is significantly affected by low-molecular-weight maleic acid adducts formed as by-products at the time of producing a maleic acid-modified polypropylene-based resin.

According to the invention, the following fiber-reinforced resin composition and molded article produced from the composition are provided.

1. A fiber-reinforced resin composition comprising:

(A) a polyolefin-based resin;

(B) glass fibers having (B1) an average diameter of 3 to 30 μm and (B2) an average aspect ratio of 50 to 6000; and

(C) an acid-modified polypropylene-based resin exhibiting (C1) a change in amount of acid added, measured by Fourier transform infrared spectroscopy, before and after being treated in methyl ethyl ketone at 70° C. for three hours of 0.8 mass % or less, and having (C2) a melt flow rate (load: 2.16 kg, temperature: 230° C.) of 20 to 2000 g/10 min;

the composition containing the components (A) to (C) at such a ratio (mass ratio) that (B):[(A)+(C)]=5 to 80:95 to 20 and (A):(C)=0 to 99.5:100 to 0.5.

2. The fiber-reinforced resin composition according to 1; wherein the polyolefin-based resin (A) is a polypropylene-based resin.
3. A molded article produced from the fiber-reinforced resin composition according to 1 or 2.
4. A maleic acid-modified polypropylene-based resin exhibiting (C1) a change in amount of acid added, measured by Fourier transform infrared spectroscopy, before and after being treated in methyl ethyl ketone at 70° C. for three hours of 0.8 mass % or less, and having (C2) a melt flow rate (load: 2.16 kg, temperature: 230° C.) of 20 to 2000 g/10 min.

According to the invention, a fiber-reinforced resin composition with improved strength and a molded article produced from the composition can be provided.

The composition according to invention exhibits a more excellent performance when a solvent-soluble part is removed.

### BRIEF DESCRIPTION OF THE DRAWING

FIG. 1 is a view showing a device for producing long fiber-reinforced resin pellets employed in the examples and the comparative examples.

### BEST MODE FOR CARRYING OUT THE INVENTION

The fiber-reinforced resin composition according to the invention comprises (A) a polyolefin-based resin, (B) specific glass fibers, and (C) a specific acid-modified polypropylene-based resin.

As the polyolefin-based resin (A), a polypropylene-based resin is preferred. A propylene homopolymer or an ethylene-propylene block copolymer is more preferred. An even more preferable polyolefin-based resin is a propylene homopolymer.

It is preferable that the polypropylene-based resin (A) meet the following requirements.

The melt flow rate (“MFR”) (temperature: 230° C., load: 2.16 kg) is normally 1 to 600 g/10 min, preferably 10 to 400 g/10 min, more preferably 30 to 300 g/10 min, and even more preferably 50 to 150 g/10 min. If the melt flow rate of the polypropylene-based resin exceeds 600 g/10 min, toughness may be decreased. On the other hand, a melt flow rate of less than 1 g/10 min may result in difficulty in molding.

The crystallinity (mmmm fraction) of the homopolymerized part is normally 90% or more, preferably 93% or more, and more preferably 96% or more.

The crystallization temperature (Tc) (B) measured by DSC is normally 80 to 130° C., preferably 90 to 125° C., and more preferably 110 to 120° C.

The amount of components with a molecular weight of 1,000,000 or more measured by GPC is normally 0.5% or more, preferably 1% or more, and even more preferably 2% or more. The molecular weight distribution (Mw/Mn) measured by GPC is normally 2 to 10, preferably 2 to 6, and especially preferably 3 to 5.

The amount of inorganic neutralizer contained in the polyethylene-based resin is preferably 0.001 to 0.5 mass %, more preferably 0.01 to 0.1 mass %, and especially preferably 0.05 mass %. If the amount of inorganic neutralizer is 0.001 mass % or less, catalyst residues may cause corrosion of a die of a molding machine. On the other hand, if the amount of inorganic neutralizer exceeds 0.5 mass %, the strength of the resin may be lowered. Examples of the inorganic neutralizer include those described in JP-A-2003-238748. Among them, hydrotarcites are particularly preferred.

The polypropylene-based resin may be prepared by known methods including those disclosed in JP-A-11-71431 and JP-A-2002-249624. For example, by using a polymerization catalyst, the polypropylene-based resin may be prepared by slurry polymerization, vapor phase polymerization, or liquid phase block polymerization of propylene or the like. A batch or continuous polymerization method may be employed.

A commercially available polypropylene-based resin may be employed. A commercially available polypropylene resin of which the fluidity is adjusted by the addition of an organic peroxide, or a mixture of a plurality of commercially available polypropylene-based resins may also be employed. These resins may be employed as the component of the resin composition or for dilution blending.

Examples of the commercially available propylene-based resin are given below.

### 1. Propylene-Based Resins Produced by Idemitsu Kosan Co., Ltd.

### (1) Propylene Homopolymers

J-2003GP (MFR=21), J-2000GP (MFR=21), J-903GP (MFR=13), J-900GP (MFR=13), J-700GP (MFR=8), J-3003GV (MFR=30), J-3000GV (MFR=30), J-3000GP (MFR=30), H-100M (MFR=0.5), H-700 (MFR=7), Y-2000GP (MFR=20), Y-6005GM (MFR=60), E-105GM (MFR=0.5), F-300SV (MFR=3), and Y-400GP (MFR=4)

### (2) Propylene-Ethylene Block Copolymers

J-6083HP (MFR=60), J-5066HP (MFR=50), J-5051HP (MFR=50), J-3054HP (MFR=40), J-3056HP (MFR=40), J-950HP (MFR=32), J-762HP (MFR=13), J-466HP (MFR=3), JR3070HP (MFR=30), and J-786HV (MFR=13)

### (3) Propylene-Ethylene Random Copolymers

J-3021GA (MFR=30), J-3021GR (MFR=30), and J-2021GR (MFR=20)

### 2. Polypropylene-Based Resins Produced by SunAllomer, Ltd.

### (1) Propylene Homopolymers

PM900M (MFR=30), PM900A (MFR=30), PM802A (MFR=20), PM801Z (MFR=13), PM600Z (MFR=7.5), PM600M (MFR=7.5), PM600H (MFR=7.5), PM600A (MFR=7.5), PF-611 (MFR=30), and PF-814 (MFR=3).

### (2) Propylene-Ethylene Block Copolymers

PMB70X (MFR=63), PMB65X (MFR=63), PMB60W (MFR=63), PMB60A (MFR=63), PMA60Z (MFR=45), PMA80X (MFR=43), PMA60A (MFR=43), PM965C (MFR=35), PM953M (MFR=30), and PM761A (MFR=9.5)

### (3) Propylene-Ethylene Random Copolymers

PVC20M (MFR=85), PMC20M (MFR=85), PMA20V (MFR=45), PV940M (MFR=30), PM822V (MFR=20), PM811M (MFR=13), and PM731V (MFR=9.5)

### 3. Polypropylene-Based Resins Produced by Japan Polypropylene Corporation (Novatec-PP)

### (1) Propylene Homopolymers

MA3 (MFR=11), MA3AH (MFR=12), and MA03 (MFR=25)

### (2) Propylene-Ethylene Random Copolymers

BC06C (MFR=60), BC05B (MFR=50), BC03GS (MFR=30), BC03B (MFR=30), BC03C (MFR=30), BC2E (MFR=16), BC3L (MFR=10), BC3H (MFR=8.5), BC3F (MFR=8.5), and BC4ASW (MFR=5),

### BC6DR (MFR=2.5), BC6C (MFR=2.5), and BC8 (MFR=1.8)

### 4. Polypropylene-Based Resins Produced by Mitsui Chemical, Inc. (Mitsui Polypro)

### (1) Propylene Homopolymers

J139 (MFR=50), J136 (MFR=20), CJ700 (MFR=10), J108M (MFR=45), J107G (MFR=30), J106G (MFR=15), and J105G (MFR=9)

### (2) Propylene-Ethylene Block Copolymers

J709UG (MFR=55), J708UG (MFR=45), J830HV (MFR=30), J717ZG (MFR=32), J707EG (MFR=30), J707G (MFR=30), J715M (MFR=9), J705UG (MFR=9), J704UG (MFR=5), and J702LB (MFR=1.8)

### (3) Propylene-Ethylene Random Copolymers

J229E (MFR=52) and J226E (MFR=20)

Examples of the glass fibers (B) employed in the fiber-reinforced resin composition of the invention include fibers in the form of filaments prepared by subjecting glass such as electrical glass (E Glass), chemical glass (C Glass), alkali glass (A Glass), high strength glass, or alkali-resistant glass to melt spinning. Of these, electrical glass is preferred.

The average diameter of the glass fibers (B) is 3 to 30 μm, preferably 11 to 25 μm, more preferably 14 to 23 μm, and especially preferably 14 to 18 μm. If the diameter of the glass fibers is too small, the fibers tend to break, which results in lowered productivity of reinforced resin bundles. In addition, during the continuous production of pellets, the number of fibers to be bundled is increased, which leads to a more complicated process of combining fiber bundles as well as to lowered productivity. When the favorable pellet length is specified, if the fiber diameter is too large, the aspect ratio of the fibers is reduced. This may cause the reinforcement effect to deteriorate.

In the case of long-fiber pellets, it is preferred that the pellet length be 4 to 20 mm and the pellet diameter be 0.5 to 4 mm.

As the long glass fibers, a bundle of continuous glass fibers may be employed. These fiber bundles are commercially available as a glass roving. Other than the glass roving, a cake described in JP-A-6-114830 may be used without restrictions. Glass chopped strands may also be employed. However, in order to suppress the aspect ratio to the required range, it is preferred to employ glass fiber bundles such as a roving and a cake.

Glass fibers with a specific cross-sectional shape, such as an ellipse, a cocoon-like shape, and a flat shape, described in JP-A-61-187137, JP-A-61-219732, JP-A-61-219734, JP-A-7-291649, JP-A-7-10591, “Seikei Kakou”, Vol. 15, Issue 9, 2003, page 612 (Yamao et al.), and the like may be used.

The average aspect ratio of the glass fibers (B) in the resin composition is 50 to 6000, preferably 75 to 2000, more preferably 100 to 1500, and even more preferably 200 to 1000. If the average aspect ratio is too small, the reinforcement effect of the fibers may become insufficient. On the other hand, an excessively large average aspect ratio may lead to unstable plasticization during molding and also to insufficient dispersion of the glass fibers.

To adjust the average aspect ratio of the glass fibers (B) in the resin composition to 50 or larger, the following means may be employed, for example. In the case where glass fibers are produced by kneading, restrictions on methods and conditions may be minimized to suppress occurrence of fiber breakage. Long chopped strands with a length of 6 mm or more may be employed. Glass fibers with a smaller fiber diameter (3 to 7 μm) may be also employed. However, it may be difficult to obtain a sufficient aspect ratio by these methods. It is common, as well as preferable, to use long-fiber pellets prepared by drawing or the like.

The glass fibers (B) according to the invention are preferably treated with a silane coupling agent, in particular, aminosilane.

Also preferable are glass fibers which have been subjected to sizing treatment with a urethane-based or an olefin-based emulsion. In particular, it is preferred that the glass fibers be treated with a resin emulsion containing the acid-modified polypropylene-based resin (C) of the invention before producing the resin composition.

Examples of the glass roving which may be employed as the glass fibers (B) according to the invention are given below.

### 1. Glass Roving Produced by Asahi Fiber Glass Co., Ltd.

ER2220 (fiber diameter of 16 μm, treated with an aminosilane coupling agent and an olefin-based emulsion; about 4000 fibers are bundled)

ER740 (fiber diameter of 13 μm, treated with an aminosilane coupling agent and an olefin-based emulsion; about 2000 fibers are bundled)

### 2. Glass Roving Produced by Nippon Electric Glass Co., Ltd.

ER2310T-441N (fiber diameter of 17 μm, treated with an aminosilane coupling agent and an olefin-based emulsion; about 4000 fibers are bundled)

### 3. Glass Roving Produced by Central Glass Co., Ltd.

ERS2310-LF701 (fiber diameter of 17 μm, treated with an aminosilane coupling agent and a mixed emulsion of a urethane-based emulsion and an olefin-based emulsion; about 4000 fibers are bundled)

ERS2310-LF702 (fiber diameter of 17 μm, treated with an aminosilane coupling agent and a urethane-based emulsion; about 4000 fibers are bundled)

### 4. Glass Roving Produced by NSG Vetrotex

RO99 2400 P319 (fiber diameter of 17 μm, treated with an aminosilane coupling agent and an olefin-based emulsion, about 4000 fibers are bundled)

Examples of commercially available chopped strands are given below.

### 1. Chopped Strands Produced by Asahi Fiber Glass Co., Ltd.

03 JA FT17 (fiber diameter of 10 μm, treated with an aminosilane coupling agent and a urethane-based emulsion)

03 MA FT170 (fiber diameter of 13 μm, treated with an aminosilane coupling and a urethane-based emulsion)

03 JA 486A (fiber diameter of 10 μm, treated with an aminosilane coupling agent and an epoxy-based emulsion)

03 MA 486A (fiber diameter of 13 μm, treated with an aminosilane coupling agent and an epoxy-based emulsion)

03 JA FT760A (fiber diameter of 10 μm, treated with an aminosilane coupling agent and an olefin-based emulsion)

03 MA FT170A (fiber diameter of 13 μm, treated with an aminosilane coupling agent and an olefin-based emulsion)

### 2. Chopped Strands Produced by Nippon Electric Glass Co., Ltd.

03T-488DE (fiber diameter of 6 μm, treated with an aminosilane coupling agent and a urethane-based emulsion)

T-480H (fiber diameter of 10.5 μm, treated with an aminosilane coupling agent and an olefin-based emulsion)

T-488 GH (fiber diameter of 10.5 μm, treated with an aminosilane coupling agent and a urethane-based emulsion)

### 3. Chopped Strands Produced by NSG Vetrotex

EC10 968 (fiber diameter of 10 μm, treated with an aminosilane coupling agent and an olefin-based emulsion)

EC13 968 (fiber diameter of 13 μm, treated with an aminosilane coupling agent and an olefin-based emulsion)

RES03X-TP15 (fiber diameter of 10 μm, treated with an aminosilane coupling agent and an olefin-based emulsion)

RES03X-TP B0160 (fiber diameter of 10 μm, treated with an epoxysilane/aminosilane coupling agent and an epoxy-based emulsion)

### 4. Chopped Strands Produced by Nittobo Co., Ltd.

CS 3J-956 (fiber diameter of 11 μm, treated with an aminosilane coupling agent and an acryl-based emulsion)

CS 3J-254 (fiber diameter of 13 μm, treated with an aminosilane coupling agent and an acryl-based emulsion)

CS 3PE-956 (fiber diameter of 11 μm, treated with an aminosilane coupling agent and a urethane-based emulsion)

The acid-modified polypropylene-based resin (C) to be used in the fiber-reinforced resin composition according to the invention is prepared by modifying a polypropylene-based resin with an acid. As the acid, a carboxylic acid or derivatives thereof is preferable. It is especially preferable that the polypropylene-based resin be modified with maleic acid.

As the polypropylene-based resin used as the starting material for the acid-modified polypropylene-based resin, a propylene homopolymer or an ethylene-propylene random copolymer is preferable. The most preferable polypropylene-based resin is a propylene homopolymer.

The melt flow rate of the polypropylene-based resin used as the starting material for the acid-modified polypropylene-based resin is normally 0.05 to 20 g/10 min, preferably 0.1 to 10 g/10 min, more preferably 0.2 to 4 g/10 min, and even more preferably 0.3 to 2 g/10 min.

As the polypropylene-based resin used for the acid-modified polypropylene-based resin, the resins given as examples of the polyolefin-based resin (A) may be employed.

Examples of the acid for use in modification include carboxilic acids and derivatives thereof, such as acetic acid, acrylic acid, malonic acid, succinic acid, maleic acid, fumaric acid, benzoic acid, 2-naphthoic acid, phthalic acid, iso-phthalic acid, terephthalic acid, isonicotinic acid, 2-furoic acid, formic acid, propionic acid, propiolic acid, butyric acid, iso-butyric acid, methacrylic acid, palmitic acid, stearic acid, oleic acid, oxalic acid, glutalic acid, adipic acid, cinnamic acid, glycolic acid, lactic acid, glyceric acid, tartaric acid, citric acid, glyoxylic acid, pyruvic acid, acetoacetic acid, benzyl acid, anthranic acid, and ethylenediamine tetraacetic acid. Of these, dicarboxlic acids are preferable. Especially preferable is maleic acid.

As the method for producing the acid-modified polypropylene-based resin, known methods described in JP-A-8-143739, JP-A-2002-20560, JP-A-7-316239, JP-A-8-127697 and JP-A-7-232324 may be used.

For example, a solution method in which an organic peroxide, maleic acid, and polypropylene are reacted in a solvent; a melt method in which an organic peroxide, maleic acid, and polypropylene are melt kneaded; and a thermal decomposition method in which thermally decomposed polypropylene is reacted with maleic acid may be employed. The solution method has a disadvantage in that, as a side reaction with an organic solvent is likely to occur, the organic solvent tends to remain as a residue. The thermal decomposition method has a drawback in which the molecular weight distribution of the resulting polypropylene tends to be too large. For these reasons, the melt method is preferable.

Known reaction initiators, such as organic peroxides, may be used for the production of the acid-modified polypropylene-based resin.

An organic peroxide as referred to herein is a derivative of hydrogen peroxide (H—O—O—H) having a structure in which one or two hydrogen atoms of the hydrogen peroxide may be replaced with an organic free radical. The organic peroxide is characterized by the presence of a peroxide bond “O—O” in its molecule.

Typical examples of usable organic peroxides include dialkyl peroxides, ketone peroxides, diacyl peroxides, hydroperoxides, peroxyl ketals, alkyl peresters, and percarbonates. Of these, diacyl peroxides are preferable.

Preferable diacyl peroxides include 1,3-bis-(t-butylperoxyisopropyl)benezene, for example, Perkadox 14, Bisblake P, AD-2, and Perkadox 14-C (produced by Kayaku Akzo Corp.), 2,5-dimethyl-2,5-di-(t-butylperoxy)heptane, 3,6,9-triethyl-3,6,9-trimethyl-1,4,7-triperoxonane, for example, Trigonox 301 (produced by Kayaku Akzo Corp.), and di-t-butylperoxide, for example, Kaybutyl D (produced by Kayaku Akzo Corp.). Of these, 1,3-bis-(t-butylperoxyisopropyl)benzene is especially preferable in respect of the half life, odor, and color balance.

Normally, an organic peroxide of which the half life is one minute at a temperature of 90 to 200° C. is employed. An organic peroxide of which the half life is one minute at a temperature of 120 to 200° C. is preferable, 150 to 200° C. is more preferable, and 160 to 200° C. is especially preferable. The active hydrogen content of the organic peroxide is normally 2 to 12%, and preferably 3 to 6%. If the temperature at which the half life of the organic peroxide is one minute is lower than 90° C., the organic peroxide deactivates quickly, resulting in insufficient reaction. It is hard to find an organic peroxide on the market of which the half life is one minute at a temperature higher than 200° C.

The acid-modified polypropylene-based resin (C) according to the invention shows a change in the amount of acid added, measured by Fourier transform infrared spectroscopy, before and after being treated in methyl ethyl ketone at 70° C. for three hours of 0.8 mass % or less, preferably 0.4 mass % or less, more preferably 0.3 mass % or less, still more preferably 0.18 mass % or more, particularly preferable 0.08 mass % or less, and most preferably 0.02 mass % or less.

A small change in the amount of acid added indicates a low content of low-molecular-weight maleic acid adducts.

The detailed composition of the low-molecular-weight maleic acid adduct has not yet been fully elucidated. It can be anticipated that the low-molecular-weight maleic acid adduct includes a polypropylene oligoner to which maleic acid is added, an organic peroxide, a cross-linking agent or a solvent to which maleic acid is added, or unreacted maleic acid.

Preferred methods for removing low-molecular-weight maleic acid adducts include, but are not limited to, degasification, washing, and purification. Since it is difficult to remove low-volatile components by degasification, washing or purification is more preferred. An especially preferred method is washing with a heated solvent at 30 to 120° C.

### (1) Degasification

After reducing the pressure through a vent at the time of extrusion, the acid-modified polypropylene-based resin is heated under reduced pressure (vacuum) and dried with hot air.

### (2) Washing

Use of a washing solvent such as methyl ethyl ketone and an acetone/heptane mixed solution is preferred (it is preferred that the washing solvent be heated to 30 to 120° C., and more preferably 60 to 110° C.). After washing with the solvent, separation and drying are performed. Other employable methods include washing with steam, hot water, and water. It is efficient to wash with the washing solvent.

### (3) Purification

The acid-modified polypropylene-based resin is dissolved in a heated solvent (paraxylene, xylene, toluene, benzene, n-heptane, chlorobenzene, or the like), and precipitated using reprecipitation solvent (acetone, acetone/methanol mixture, or the like). After filtration, drying is performed by, for example, vacuum drying.

The amount of acid added to the acid-modified polypropylene-based resin (part insoluble in methyl ethyl ketone) is normally 0.4 to 10 mass %, preferably 0.7 to 2.9 mass %, more preferably 0.7 to 1.8 mass %, even more preferably 0.9 to 1.8 mass %, and especially preferably 0.9 to 1.5 mass %. If the amount of acid added is less than 0.4 mass %, the strength of the resin may be insufficient. If the amount of acid added exceeds 10 mass %, the melt flow rate may increase or it may be difficult to remove soluble matters.

The change rate of the amount of acid added before and after 3-hour treatment of the film with methyl ethyl ketone at 70° C. [=change in the amount of acid added before and after the treatment/the amount of acid added after treatment] is normally 0.4 or less, preferably 0.3 or less, more preferably 0.2 or less, even more preferably 0.1 or less, and especially preferably 0.05 or less.

The melt flow rate (MFR) of the acid-modified polypropylene-based resin (measured according to ASTM D-1238, at a load of 2.16 kg and a temperature of 230° C.) is 20 to 2000 g/10 min, preferably 60 to 1500 g/10 min, more preferably 130 to 1000 g/10 min, even more preferably 260 to 750 g/10 min, and especially preferably 260 to 550 g/10 min.

If the melt flow rate is 600 g/10 min or more, the measurement accuracy will be lowered. Therefore, in such a case, measurement is performed at a load of 1.05 kg and a temperature of 190° C., and the measurement result is converted by the following formula.

MFR(230° C., 2.16 kg)=6.2×MFR(190° C., 1.05 kg)

If the melt flow rate of the acid-modified polypropylene-based resin exceeds 2000 g/10 min, strength and durability may be lowered. The melt flow rate of less than 20 g/10 min may lead to lowered strength and deteriorated appearance.

The methods for adjusting the melt flow rate of the acid-modified polypropylene-based resin (maleic acid-modified polypropylene-based resin) include changing the molecular weight of polypropylene (JP-A-2002-20560), changing the reaction temperature, changing the concentrations of maleic acid and an organic peroxide, adding a cross-linked polymer (e.g. polybutadiene) (JP-A-8-143739), and adding a polyfunctional compound.

The number average molecular weight (Mn) of the acid-modified polypropylene-based resin measured by GPC is normally 12,000 to 60,000, preferably 14,000 to 55,000, more preferably 16,000 to 50,000, even more preferably 18,000 to 46,000, especially preferably 23,000 to 38,000, and most preferably 26,000 to 34,000.

The molecular weight distribution Mw/Mn measured by GPC is normally 2 to 10, preferably 2 to 4, and especially preferably 2.5 to 3.5.

The content of components with a molecular weight of 20,000 or less measured by GPC is normally 40% or less, preferably 30% or less, and especially preferably 20% or less.

The content of components with a molecular weight of 5,000 or less measured by GPC is normally 10% or less, preferably 6% or less, more preferably 4% or less, and especially preferably 3% or less.

The average number of functional groups per molecule of the acid-modified polypropylene-based resin obtained from the amount of functional groups added measured by FT-IR and the number average molecular weight measured by GPC is normally 1.5 to 12 (number/molecule), preferably 1.5 to 6, more preferably 1.5 to 4, even more preferably 2 to 4, and especially preferably 2.4 to 3.6.

If the average number of functional groups per molecule exceeds 12 (number/molecule), the strength may be lowered, as the resin tends to be bonded to the glass fiber surface at a number of points. On the other hand, if the average number of functional groups per molecule is less than 1.5 (number/molecule), a propylene-based resin with no maleic acid group added may be unexpectedly formed, resulting in lowered efficiency.

The limiting viscosity of the acid-modified polypropylene-based resin (measured in tetralin at 135° C.) is normally 0.4 to 1.8, preferably 0.4 to 1.1, more preferably 0.40 to 1.05, even more preferably 0.50 to 1.00, and especially preferably 0.60 to 0.95.

The crystallinity (mmmm fraction) of the acid-modified polypropylene-based resin is normally 85 to 99.9%, preferably 88 to 98%, and especially preferably 90 to 94%.

The crystallization temperature (Tc) (C) of the acid-modified polypropylene-based resin measured by DSC is normally 80 to 130° C., preferably 90 to 125° C., and more preferably 110 to 120° C. It is preferred that the conditions defined by the formula: Tc(C)<Tc(B)−5° C. be satisfied.

The amount of residual peroxides of the acid-modified polypropylene-based resin is normally 1,000 ppm or less, preferably 500 ppm or less, even more preferably 100 ppm or less, and especially preferably 50 ppm or less.

The yellow index (YI: measured according to JIS K7105-1981) of the acid-modified polypropylene-based resin is normally 0 to 80, preferably 0 to 50, and especially preferably 0 to 20. If the yellow index exceeds 80, the molded article may yellow, which results in a deteriorated appearance.

The ring-opening ratio of the maleic acid group of the acid-modified polypropylene-based resin measured by FT-IR is normally 80% or less, preferably 70% or less, and more preferably 50% or less. If the ring-opening ratio exceeds 80%, the ring-opened maleic acid group may undergo a ring-closing reaction during molding to produce water, causing silver streaks to be formed. This causes the appearance to deteriorate.

The content of low-molecular-weight components of the acid-modified polypropylene-based resin (the content of low-molecular-weight-components is measured by a method in which the components are dissolved in xylene, the resulting slurry is washed with acetone, the washing solution is then subjected to condensation and evaporation to dryness, and the dryness is measured) is normally 3 mass % or less, preferably 0.5 mass % or less, more preferably 0.3 mass % or less, and especially preferably 0.1 mass % or less.

The volatile content of the acid-modified polypropylene-based resin (comparison is made on the weights before and after overdrying) is normally 0.5 mass % or less, preferably 0.3 mass % or less, more preferably 0.1 mass % or less, even more preferably 0.05 mass % or less, and especially preferably 0.02 mass % or less. If the volatile content exceeds 0.5 mass %, unpleasant odors may be generated and the appearance may become poor (occurrence of gas whirling).

The amount of gel of the acid-modified polypropylene-based resin (the amount of components which do not pass through a 5μ millipore filter according to the melt pressure penetration method) is normally 2 mass % or less, preferably 1 mass % or less, more preferably 0.5 mass % or less, and especially preferably 0.2 mass % or less. An amount exceeding 2 mass % may result in a deteriorated appearance.

The ratio of the polyolefin-based resin (A), the glass fibers (B), and the acid-modified polypropylene-based resin (C) in the fiber-reinforced resin composition of the invention is (B):[(A)+(C)]=5 to 80:95 to 20, preferably 10 to 70:90 to 30, and more preferably 35 to 55:65 to 45.

In addition, (A):(C) is normally 0 to 99.5:100 to 0.5, more preferably 80 to 99:20 to 1, even more preferably 90 to 98:10 to 2, and especially preferably 94 to 98:6 to 2.

Various known additives may be added to the composition of the invention depending on the application. Examples of such additives include additives for modification including dispersants, lubricants, plasticizers, mold releasing agents, flame retardants, antioxidants (phenol-based antioxidants, phosphorus-based antioxidants, and sulfur-based antioxidants), antistatic agents, light stabilizers, UV absorbers, metal inerting agents, crystallization accelerators (nuclei-forming agents), alkaline earth metal compounds such as magnesium hydroxide and aluminum hydroxide, additives for modification such as foaming agents, cross-linking agents, and antibacterial agents; coloring agents including carbon black, zinc sulfide, pigment, and dye; fillers in the form of powder such as titanium oxide, red iron oxide, azo pigments, anthraquinone pigments, phthalocyanine, talc, calcium carbonate, mica, clay, graphite, and glass flake; short-fiber fillers including wallastonite and milled fibers; organic fillers including cellulose, bamboo fibers, and aramid fibers; and whiskers including potassium titanate.

Various elastomers may be added to the composition according to the invention depending on the application. As olefin-based elastomers, elastomers described in JP-A-2002-3616 may be employed, for example.

The fiber-reinforced resin composition according to the invention may be used in the form of a mat (glass mat sheet), a prepreg, resin pellets, or the like. It is preferred that the resin composition be in the form of resin pellets which can be readily molded.

The method of producing the fiber-reinforced resin composition of the invention is described below.

It is preferred that the fiber-reinforced resin composition be long-fiber pellets, which may be prepared by the methods described in Japanese Patent No. 3234877 or in a document titled “Seikei Kakou”, Vol. 5, Issue 7, page 454 (1993) or by other known methods. For example, the method described below may be employed.

Long-fiber reinforced-resin pellets may be prepared readily by introducing a roving consisting of thousands of reinforcement fibers into an impregnation die where the filaments are uniformly impregnated with the molten polyolefin-based resin. The pellets are then cut into a required length.

For example, while the molten resin is supplied from an extruder to an impregnation die provided at the front of the extruder, a continuous glass fiber bundle is caused to pass through to impregnate the glass fiber bundle with the molten resin. Then, the molten resin is withdrawn through a nozzle, and pelletized to a specific length. It is also possible to employ a method including dry-blending a polyolefin-based resin, modifier, organic peroxide, and the like and sending the blend into the hopper of an extruder so that modification and supply can be performed simultaneously.

There is no restriction on the method of impregnation. Examples of employable methods include: a method in which a roving is caused to pass through a resin powder fluidized bed, and the roving is heated to a temperature higher than the melting point of the resin (JP-A-46-4545); a method in which a reinforced fiber roving is caused to pass through a polyolefin-based powder fluidized layer so that the polyolefin-based resin powder is attached to the roving, the roving is heated to a temperature higher than the melting point of the polyolefin-based resin(JP-A-46-4545); a method in which a reinforced fiber roving is impregnated with a molten polyolefin-based resin by means of a cross head die (JP-A-62-60625, JP-A-63-132036, JP-A-63-264326, and JP-A-1-208118); a method in which resin fibers and reinforced fiber resin rovings are mixed and heated to a temperature higher than the melting point of the resin (JP-A-61-118235); a method in which a number of rods are arranged inside the die, a roving is wound around each rod in a zig-zag manner to open the fibers and impregnate the roving with the resin (JP-A-10-264152); a method in which a roving is caused to pass through a pair of opened fiber pins while avoiding contact of the roving with the pin (WO97/19805); a method in which strands of roving are formed by means of a roller (JP-A-5-169445); a method in which a mixture of glass fibers and a polyolefin-based resin is prepared and then heated (NSG Vetrotex); a method utilizing intake air (JP-A-9-323322); and a method in which variations of glass filament diameters are suppressed within a specific range (JP-A-2003-192911). Any of the above methods can be employed.

Glass fibers with a specific cross-sectional shape (an ellipse shape, a cocoon-like shape, or a flat shape) are preferable to attain sufficient impregnation.

Short-fiber reinforced pellets may be prepared by subjecting part or all of the components (A) to (C) to melt kneading. The aspect ratio is adjusted to a desired range by selecting the type of glass fibers as the starting material, by adjusting the kneading conditions, or the like. For example, adjusting the rotational speed of a screw or using a screw which does not break the fibers may be employed.

The molded article according to the invention may be prepared by a known method including injection molding, extrusion molding, hollow molding, compression molding, injection/compression molding, gas-assisted injection molding, or foam injection molding. Of these, injection molding, compression molding, and injection/compression molding are preferable.

The molded article according to the invention may be used for injection molding compounds including in-line compounds and direct compounds as described in Plastics Info World 11/2002, pages 20 to 35.

Normally, since the fibers tend to break during molding, the average aspect ratio of the fibers in the molded article is likely to be smaller than the average aspect ratio of the fibers in the composition. The aspect ratio of the fibers in the molded article is normally 40 to 2000, preferably 60 to 1000, even more preferably 75 to 750, and especially preferably 100 to 500. If the average aspect ratio is less than 40, the strength of the molded article may be insufficient. On the other hand, if the average aspect ratio exceeds 2000, the appearance may deteriorate due to insufficient dispersion.

The molded article may be prepared by molding the resin composition according to the invention or molding the composition after blending with a diluent. The fiber-reinforced resin pellets and a diluent (e.g. a polyolefin-based resin similar to the fiber-reinforced resin pellets) may be blended by dry blending. To maintain the fiber length in the composition and to attain improvement in toughness, impact resistance, and durability, it is preferred that the dry blend of fiber-reinforced resin pellets and a diluent be directly supplied to a molding device such as an injection molding device without supplying the dry blend to an extruder. The amount of diluent varies depending on the content of the reinforcement fibers in the fiber-reinforced resin pellets and the required content of the reinforcement fibers in the final molded article. In view of the improvement in toughness, impact resistance, and durability, the amount of diluent is preferably 20 to 85 wt %.

### EXAMPLES

The following components (A) to (C) were employed in the examples and the comparative examples.

### 1. Polyolefin-Based Resin (A)

PP-A: J-3000GV (polypropylene homopolymer with a melt flow rate of 30, produced by Idemitsu Kosan Co., Ltd., which had been decomposed with Perkadox 14 (peroxide) to adjust the melt flow rate to 80)
PP-B: J-6083HP (propylene-ethylene block copolymer with a melt flow rate of 60, produced by Idemitsu Kosan Co., Ltd.)

### 2. Glass Fibers (Reinforcement Fibers) (B)

GF-1: ER2220 (glass roving with an average fiber diameter of 16 μm which had been treated with an aminosilane coupling agent and an olefin-based emulsion, produced by Asahi Fiber Glass Co., Ltd.)
GF-2: 03 JA FT17 (chopped strand of 3 mm in length, with an average fiber diameter of 10 μm, which had been treated with an aminosilane coupling agent and a urethane-based emulsion, produced by Asahi Fiber Glass Co., Ltd.)
GF-3: T-480H (chopped strand of 3 mm in length, with an average fiber diameter of 10.5 μm, which had been treated with an aminosilane coupling agent and an olefin-based emulsion, produced by Asahi Fiber Glass Co., Ltd.)

### 3. Maleic Acid-Modified Polypropylene-Based Resin (C)

3-1. Acid-modified polypropylene-based resins C-1 to C-12 having the properties shown in Table 1 were employed.
(1) The amounts (a) and (b) of maleic acid added were measured by the following methods.

### (i) Amount (b) of Maleic Acid Added to Maleic Acid-Modified Polypropylene-Based Resin

By using dodecasuccinic acid and polypropylene powder for adjusting the concentration (product name: H-700, produced by Idemitsu Kosan Co., Ltd), the peak area was plotted against the amount of maleic acid to obtain a calibration curve.

Subsequently, the sample was pre-heated at 230° C. for 10 minutes by hot pressing, pressed for 4 minutes (5 Mpa), and pressed for 3 minutes by cold pressing (5 Mpa) to obtain a film with a thickness of about 0.1 mm.

A part of the resulting film (15 mm×20 mm×0.1 mm) was washed by immersing in 10 ml of methyl ethyl ketone (MEK) at 70° C. for 3 hours. Then, the film was removed, air-dried, and vacuum dried at 130° C. for 2 hours.

Within 2 hours after the drying, the FT-IR transmission spectrum was obtained, and the peak area at 1670 to 1810 cm⁻¹ of the FT-IR spectrum was calculated. The peak area was compared with the above-obtained calibration curve to obtain the amount (b) of carboxylic acid group added to the maleic acid-modified polypropylene-based resin.

### (ii) Total Amount (a) of Maleic Acid Added

By using dodecasuccinic acid and polypropylene powder for adjusting concentration (product name: H-700, produced by Idemitsu Kosan Co., Ltd), the peak area was plotted against the amount of maleic acid to obtain a calibration curve.

Subsequently, the sample was pre-heated at 230° C. for 10 minutes by hot pressing, pressed for 4 minutes (5 Mpa), and pressed for 3 minutes by cold pressing (5 Mpa) to obtain a film with a thickness of about 0.1 mm.

Within 2 hours after the preparation of the film, the FT-IR spectrum of the film was measured, and the peak area at 1670 to 1810 cm⁻¹ of the FT-IR spectrum was calculated. The peak area was compared with the above-obtained calibration curve to obtain the total amount of maleic acid added. The amount (b) of maleic acid in the maleic-acid modified polypropylene-based resin obtained in (i) above was subtracted from the total amount (a) of maleic acid added to obtain the amount (a-b) of low-molecular weight maleic acid adducts added to carboxylic acid groups.

(2) The number average molecular weight (Mn), the weight average molecular weight (Mw), and the molecular weight distribution (Mw/Mn) shown in Table 1 were obtained, according to the method described in JP-A-11-71431, from the polystyrene-reduced molecular weight distribution curve by gel permeation chromatography (GPC).

The measuring conditions are as follows.

Calibration curve: Universal Calibration

### Column: TOSOH GMHHR-H(S) HT×2

Solvent: 1,2,4-trichlorobenzene

### Temperature: 145° C.

Flow rate: 1.0 ml/min
Detector: RI (Waters alliance GPC2000)
Analysis program: HTGPC (version 1.00)

The melt flow rate (MFR) was measured according to ASTM D-1238 (load: 2.16 kg, temperature: 230° C.).

If the melt flow rate is 600 g/10 min or more, the measurement accuracy will be lowered. Therefore, in such a case, measurement is performed at a load of 1.05 kg and a temperature of 190° C., and the measurement result is converted by the following formula.

MFR(230° C., 2.16 kg)=6.2×MFR(190° C., 1.05 kg)

(3) The number of functional groups per molecule shown in Table 1 was measured according to the following method.

Number of functional groups per molecule=(0.01×A÷Mr)÷(1÷Mn)=0.1×A×Mn/Mr

where A represents the amount of functional groups added (mass %), Mr represents the molecular weight of the functional groups, and Mn represents the number average molecular weight of the acid-modified polypropylene-based resin. For example, the number of maleic acid groups (Mr=98) per molecule is almost equal to A×Mn/10,000.

TABLE 1

| | | C-1 | C-2 | C-3 | C-4 | C-5 | C-6 | C-7 | C-8 | C-9 | C-10 | C-11 | C-12 |
|---|---|---|---|---|---|---|---|---|---|---|---|---|---|
| Amount (a) | Mass % | 1.20 | 1.21 | 2.47 | 0.96 | 1.55 | 3.85 | 1.55 | 2.85 | 4.00 | 2.10 | 4.00 | 1.20 |
| Amount (b) | Mass % | 1.20 | 1.20 | 2.45 | 0.95 | 1.20 | 3.50 | 0.95 | 2.10 | 2.50 | 1.20 | 2.45 | 0.30 |
| (insoluble in MEK) | | | | | | | | | | | | | |
| Amount of | Mass % | 0.00 | 0.01 | 0.02 | 0.01 | 0.35 | 0.35 | 0.60 | 0.75 | 1.50 | 0.90 | 1.55 | 0.90 |
| low-molecular- | | | | | | | | | | | | | |
| weight maleic | | | | | | | | | | | | | |
| acid adducts | | | | | | | | | | | | | |
| (a) − (b) | | | | | | | | | | | | | |
| Number average | ×10³ | 28 | 28 | 36 | 45 | 28 | 24 | 20 | 20 | 9 | 28 | 36 | 52 |
| molecular | | | | | | | | | | | | | |
| weight (Mn) | | | | | | | | | | | | | |
| Weight average | ×10³ | 76 | 76 | 100 | 132 | 76 | 68 | 61 | 98 | 35 | 76 | 100 | 190 |
| molecular | | | | | | | | | | | | | |
| weight (Mw) | | | | | | | | | | | | | |
| Mw/Mn | — | 2.71 | 2.71 | 2.78 | 2.93 | 2.71 | 2.83 | 3.05 | 4.90 | 3.89 | 2.71 | 2.78 | 3.65 |
| MFR (load: 2.16 kg, | g/10 min | 540 | 540 | 260 | 140 | 540 | 810 | 990 | 990 | 2290 | 540 | 290 | 120 |
| temperature: | | | | | | | | | | | | | |
| 230° C.) | | | | | | | | | | | | | |
| MFR (load: 1.05 kg, | g/10 min | — | — | — | — | — | 130 | 160 | 160 | 370 | — | — | — |
| temperature: | | | | | | | | | | | | | |
| 190° C.) | | | | | | | | | | | | | |
| Limiting viscosity | dl/g | 0.62 | 0.62 | 0.78 | 0.92 | 0.62 | 0.53 | 0.49 | 0.49 | 0.33 | 0.62 | 0.76 | 0.95 |
| (η) (135° C., | | | | | | | | | | | | | |
| in tetralin) | | | | | | | | | | | | | |
| Number of | Number | 3.4 | 3.4 | 8.8 | 4.3 | 3.4 | 8.4 | 1.9 | 4.2 | 2.3 | 3.4 | 8.8 | 1.6 |
| functional groups | | | | | | | | | | | | | |
| per molecule | | | | | | | | | | | | | |

3-2. The acid-modified polypropylene-based resins C-1 to C-12 were produced by the following method. The ratio and production conditions of the acid-modified polypropylene-based resins C-1 to C-5, C-7, C-8, and C-10 to C-12 are shown in Table 2.

In the table, PP-1 is a polypropylene homopolymer (PP) with an MFR of 0.5 (H-100M, produced by Idemitsu Kosan, Co., Ltd.) and PP-2 is a polypropylene homopolymer with an MFR of 7 (H-700, produced by Idemitsu Kosan, Co., Ltd.). As for peroxides shown in the table, X-1 is Perkadox 14 (produced by Kayaku Akzo Corp.) and X-2 is 2,5-dimethyl-2,5-di(t-butylperoxy)hexine-3.

### [C-9]

Commercially available Umex 1001 (produced by Sanyo Chemical Industries) was employed without modification.

### [C-1]

C-1 was manufactured and purified according to the following method.

Using a twin-screw extruder provided with a vent, C-1 was manufactured by the melt method under the conditions shown in Table 2. Then, a functional group-containing polyolefin-based resin was heated in paraxylene (130° C.) with stirring to completely dissolve the resin. The resulting solution was reprecipitated in acetone, filtered, and vacuum-dried (at 130° C. for about 6 hours).

### [C-2 to C-5]

C-2 to C-5 were prepared under the conditions shown in Table 2 and washed.

The method for washing C-2, C-3, and C-4 was as follows.

Using a twin-screw extruder provided with a vent, C-2, C-3 and C-4 were manufactured by the melt method under the conditions shown in Table 2. Then, 1 kg of each sample was washed in a mixed solution of acetone (3 l) and heptane (3 l) in a 10 l-capacity autoclave at 85° C. for 2 hours. The liquid was then removed and allowed to stand in 10 l of acetone for 12 hours. After removing the liquid, the liquid was vacuum-dried at 130° C. for 6 hours.

C-5 was washed in the same manner as in the case of C-2 to C-4, except that the temperature of the washing solution (mixed solution) was changed to 55° C.

### [C-6]

100 phr of a polypropylene homopolymer (MFR=7 g/10 min., crystallinity: 94%, H-700, produced by Idemitsu Kosan, Co., Ltd.), 2 phr of polybutadiene (cross-linking agent, R-45HT, produced by Idemitsu Kosan Co., Ltd.), 10 phr of maleic anhydride, and 0.5 phr of an organic peroxide (Perbutyl D (di-t-butylperoxide), produced by Kayaku Akzo Corp.) were put in toluene (reaction solvent) so that the polymer concentration became 300 g/l. The mixture was incorporated into an autoclave with a capacity of 2.3 l. The mixture was heated (from normal temperature to 145° C. for 2 hours), reacted (145° C.), and cooled (30 min). The resin was transferred into 2 l of methyl ethyl ketone. The resin transferred into methyl ethyl ketone was then subjected to centrifugation, washed with methyl ethyl ketone of normal temperature (23° C.), and vacuum dried at 60° C. for 24 hours.

### [C-7, C-8, and C-10 to C-12]

C-7, C-8, and C-10 to C-12 were prepared by the melt method using a twin-screw extruder provided with a vent under the conditions shown in Table 2. Washing was not performed.

TABLE 2

| | | | | | Top feed blending | | | | | Side feed blending | | | |
|---|---|---|---|---|---|---|---|---|---|---|---|---|---|
| | | | Kneading conditions | | Polypropylene | | Maleic acid | Peroxide | | Polypropylene | | Maleic acid | Charging |
| | | Method for | Rotational | Temperature | | Part by | Part by | | Part by | | Part by | Part by | rate |
| | Method | removal | speed (rpm) | (° C.) | | weight | weight | | weight | | weight | weight | Top/Side |
| C-1 | Melt | Purification | 300 | 170 | PP-1 | 100 | 6 | X-1 | 1.2 | | 0 | 0 | 1/0 |
| | method | | | | | | | | | | | | |
| C-2 | Melt | Washing | 300 | 170 | PP-1 | 100 | 6 | X-1 | 1.2 | | 0 | 0 | 1/0 |
| | method | | | | | | | | | | | | |
| C-3 | Melt | Washing | 250 | 180 | PP-1 | 100 | 13 | X-1 | 5.2 | PP-1 | 100 | 9 | 1/1 |
| | method | | | | | | | | | | | | |
| C-4 | Melt | Washing | 100 | 180 | PP-1 | 100 | 6 | X-1 | 2.4 | PP-1 | 100 | | 1/1 |
| | method | | | | | | | | | | | | |
| C-5 | Melt | Washing | 300 | 170 | PP-1 | 100 | 6 | X-1 | 1.2 | | 0 | | 1/0 |
| | method | | | | | | | | | | | | |
| C-7 | Melt | None | 100 | 180 | PP-1 | 100 | 3.5 | X-1 | 0.6 | PP-1 | 100 | 0 | 1/1 |
| | method | | | | | | | | | | | | |
| C-8 | Melt | None | 250 | 180 | PP-1 | 100 | 13 | X-1 | 5.2 | PP-1 | 100 | 0 | 1/1 |
| | method | | | | | | | | | | | | |
| C-10 | Melt | None | 300 | 170 | PP-1 | 100 | 6 | X-1 | 1.2 | | 0 | 0 | 1/0 |
| | method | | | | | | | | | | | | |
| C-11 | Melt | None | 250 | 180 | PP-1 | 100 | 13 | X-1 | 5.2 | PP-1 | 100 | 9 | 1/1 |
| | method | | | | | | | | | | | | |
| C-12 | Melt | None | 100 | 180 | PP-2 | 100 | 2 | X-2 | 0.3 | | 0 | | 1/0 |
| | method | | | | | | | | | | | | |

### Examples 1 to 8 and Comparative Examples 1 to 4

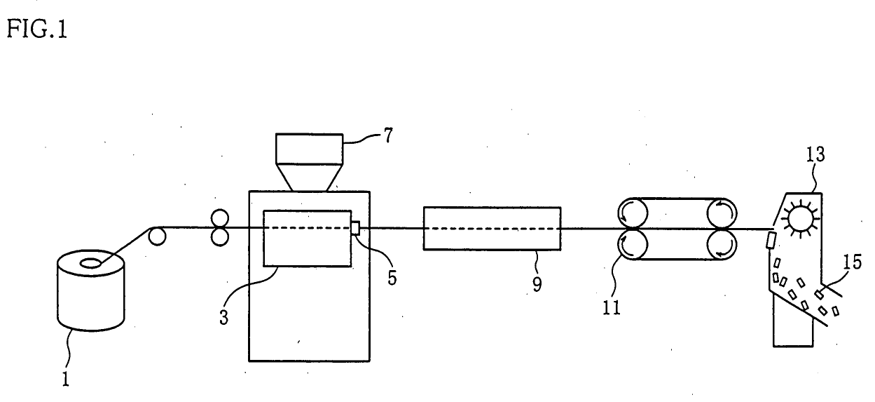

Compositions and comparative compositions were prepared using a device shown in FIG. 1.

The molten polypropylene-based resin (A) and the acid-modified polypropylene-based resin (C) were supplied at a ratio (mass ratio) shown in Table 3 from an extruder 7 to an impregnation die 3. The fiber bundle withdrawn from the glass roving (B)1 was introduced into the impregnation die 3 filled with the polypropylene-based resin (A) and the acid-modified polypropylene-based resin (C). The glass fiber bundle was impregnated with the resin component at a fiber withdraw rate of 15 m/min and a resin temperature of 280° C. The resulting product was then pelletized using a cooling bath 9, a withdrawer 11, and a pelletizer 13 to obtain pellets (GMB-1 to 12) 15. The cross section of the die 5 was circular and had a diameter of 2.3 mm.

The resulting pellets had a major-axis diameter of 2.3 mm, a minor-axis diameter of 1.9 mm, a pellet length of 8 mm, and a glass fiber content of 40 mass %.

From the resulting pellets, samples for injection molding were prepared according to the method specified in JIS K 7152-1:1999. The physical properties were measured and evaluated according to the following methods.

### (1) Tensile Stress at Break (23° C.)

Measured according to JIS K 7161-1994.

### (2) Bending Strength (23° C.)

Measured according to JIS K 7171-1994.

### (3) Flexural Modulus (23° C.)

Measured according to JIS K 7171-1994.

(4) Charpy Impact Strength (23° C., without Notch)

Measured according to JIS K 7111-1996.

### (5) Falling-Ball Cracks (1.9 kg)

A flat plate (140×140×3 mm) was prepared and secured using a jig. A ball weighing 1.9 kg was dropped to measure the height at which cracks were produced on the backside of the plate.

### (6) Weight Average Fiber Length

After incineration in an electric furnace, the lengths of 500 to 2000 fibers were measured using an image processor (produced by Luzex Co., Ltd.), and the weight average fiber length was calculated as follows.

Σ(fiber length)²/Σ(fiber length)

### (7) Average Aspect Ratio

The average fiber diameter was measured using an electron microscope.

The average aspect ratio of the fibers in the composition was calculated by dividing the average fiber length by the average fiber diameter.

The evaluation results are shown in Table 5.

### Examples 9 and 10 and Comparative Examples 5 and 6

The pellets (GMB-13 to GMB-16) were prepared in the same manner as in Example 1, except that the amount ratios were changed to those shown in Table 3.

The resulting pellets, a polypropylene-based resin (PP-A, PP-B) as a diluent, and an elastomer (A1050S, produced by Mitsui Chemicals, Inc.) were mixed at ratios shown in Table 4 to obtain blends (GBD-1 to GBD-4).

The evaluation was performed in the same manner as in Example 1. The results are shown in Table 5.

### Comparative Examples 7 to 10

Short-fiber pellets were prepared using the materials in amounts(mass ratio) shown in Table 6.

A twin-screw kneader (TEM20, produced by Toshiba Machine, Co., Ltd.) was used for kneading at a cylinder temperature of 200° C. and a screw rotational speed of 350 rpm. A propylene homopolymer and an acid-modified polypropylene-based resin were subjected to dry blending, and the resulting blend was fed from the top. Glass fibers were fed from the side. The total supply amount was 30 kg/hr. After cooling with water, the strands were cut by means of a pelletizer to obtain glass-fiber reinforced resin pellets.

The evaluation was performed in the same manner as in Example 1. The results are shown in Table 6.

TABLE 3

| | | GMB-1 | GMB-2 | GMB-3 | GMB-4 | GMB-5 | GBM-6 | GMB-7 | GMB-8 | GMB-9 |
|---|---|---|---|---|---|---|---|---|---|---|
| (A) | Type | PP-A | PP-A | PP-A | PP-A | PP-A | PP-A | PP-A | PP-A | PP-A |
| | Mass % | 59 | 59 | 59 | 59 | 59 | 59 | 59 | 59 | 59 |
| (B) | Type | GF-1 | GF-1 | GF-1 | GF-1 | GF-1 | GF-1 | GF-1 | GF-1 | GF-1 |
| | Mass % | 40 | 40 | 40 | 40 | 40 | 40 | 40 | 40 | 40 |
| (C) | Type | C-1 | C-2 | C-3 | C-4 | C-5 | C-6 | C-7 | C-8 | C-9 |
| | Mass % | 1 | 1 | 1 | 1 | 1 | 1 | 1 | 1 | 1 |

| | | GMB-10 | GMB-11 | GMB-12 | GMB-13 | GMB-14 | GMB-15 | GMB-16 |
|---|---|---|---|---|---|---|---|---|
| (A) | Type | PP-A | PP-A | PP-A | PP-A | PP-A | PP-B | PP-B |
| | Mass % | 59 | 59 | 59 | 48 | 48 | 48 | 48 |
| (B) | Type | GF-1 | GF-1 | GF-1 | GF-1 | GF-1 | GF-1 | GF-1 |
| | Mass % | 40 | 40 | 40 | 50 | 50 | 50 | 50 |
| (C) | Type | C-10 | C-11 | C-12 | C-2 | C-9 | C-2 | C-9 |
| | Mass % | 1 | 1 | 1 | 2 | 2 | 2 | 2 |

TABLE 4

| | | GBD-1 | 2 | 3 | 4 |
|---|---|---|---|---|---|
| GFMB | Type | GMB-13 | 14 | 15 | 16 |
| | Mass % | 80 | 80 | 80 | 80 |
| PP | Type | PP-A | PP-A | PP-B | PP-B |
| | Mass % | 20 | 20 | 5 | 5 |
| Elastomer | Mass % | | | 15 | 15 |

TABLE 5

| | | Examples | | | | | | | | | |
|---|---|---|---|---|---|---|---|---|---|---|---|
| | | 1 | 2 | 3 | 4 | 5 | 6 | 7 | 8 | 9 | 10 |
| | | GMB-1 | GMB-2 | GMB-3 | GMB-4 | GMB-5 | GMB-6 | GMB-7 | GMB-8 | GBD-1 | GBD-3 |
| Tensile stress | MPa | 163 | 163 | 163 | 160 | 151 | 150 | 139 | 138 | 165 | 110 |
| at break (23° C.) | | | | | | | | | | | |
| Bending strength | MPa | 238 | 238 | 238 | 234 | 224 | 222 | 211 | 210 | 242 | 150 |
| (23° C.) | | | | | | | | | | | |
| Flexural | MPa | 9100 | 9100 | 9100 | 9100 | 9100 | 9100 | 9100 | 9100 | 9100 | 6500 |
| Modulus (23° C.) | | | | | | | | | | | |
| Charpy impact | KJ/m² | 93 | 93 | 93 | 90 | 75 | 73 | 65 | 64 | 94 | 111 |
| strength (23° C., | | | | | | | | | | | |
| no notch) | | | | | | | | | | | |
| Falling-ball | cm | — | — | — | — | — | — | — | — | — | 60 |
| cracks (1.9 kg) | | | | | | | | | | | |
| Weight average | mm | 8 | 8 | 8 | 8 | 8 | 8 | 8 | 8 | 8 | 8 |
| fiber length in | | | | | | | | | | | |
| composition | | | | | | | | | | | |
| Average aspect | Average fiber | 500 | 500 | 500 | 500 | 500 | 500 | 500 | 500 | 500 | 500 |
| ratio of fibers | length/average | | | | | | | | | | |
| | fiber diameter | | | | | | | | | | |
| Weight average | mm | 2.5 | 2.5 | 2.5 | 2.5 | 2.5 | 2.5 | 2.5 | 2.5 | 2.5 | 2.5 |
| fiber length in | | | | | | | | | | | |
| molded article | | | | | | | | | | | |
| Average aspect | Average fiber | 156 | 156 | 156 | 156 | 156 | 156 | 156 | 156 | 156 | 156 |
| ratio of fibers | length/average | | | | | | | | | | |
| in molded | fiber diameter | | | | | | | | | | |
| article | | | | | | | | | | | |

| | | Comparative Examples | | | | | |
|---|---|---|---|---|---|---|---|
| | | 1 | 2 | 3 | 4 | 5 | 6 |
| | | GMB-9 | GMB-10 | GMB-11 | GMB-12 | GBD-2 | GBD-4 |
| Tensile stress | MPa | 133 | 135 | 127 | 121 | 135 | 90 |
| at break (23° C.) | | | | | | | |
| Bending strength | MPa | 206 | 209 | 201 | 194 | 207 | 120 |
| (23° C.) | | | | | | | |
| Flexural | MPa | 9100 | 9100 | 9100 | 9100 | 9100 | 6500 |
| Modulus (23° C.) | | | | | | | |
| Charpy impact | KJ/m² | 60 | 61 | 56 | 56 | 60 | 79 |
| strength (23° C., | | | | | | | |
| no notch) | | | | | | | |
| Falling-ball | cm | — | — | — | — | — | 35 |
| cracks (1.9 kg) | | | | | | | |
| Weight average | mm | 8 | 8 | 8 | 8 | 8 | 8 |
| fiber length in | | | | | | | |
| composition | | | | | | | |
| Average aspect | Average fiber | 500 | 500 | 500 | 500 | 500 | 500 |
| ratio of fibers | length/average | | | | | | |
| | fiber diameter | | | | | | |
| Weight average | mm | 2.5 | 2.5 | 2.5 | 2.5 | 2.5 | 2.5 |
| fiber length in | | | | | | | |
| molded article | | | | | | | |
| Average aspect | Average fiber | 156 | 156 | 156 | 156 | 156 | 156 |
| ratio of fibers | length/average | | | | | | |
| in molded | fiber diameter | | | | | | |
| article | | | | | | | |

TABLE 6

| | | | | Comparative Example | | | |
|---|---|---|---|---|---|---|---|
| | | | | 7 | 8 | 9 | 10 |
| Composition | Top feed | Polyolefin-based resin | PP-A | 58 | 58 | 58 | 58 |
| | | Acid-modified | C-3 | 2 | | 2 | |
| | | polypropylene-based resin | C-11 | | 2 | | 2 |
| | Side feed | Glass fiber | GF-2 | 40 | 40 | | |
| | | | GF-3 | | | 40 | 40 |

| | | | | | | |
|---|---|---|---|---|---|---|
| Physical properties of composition | Tensile stress at break (23° C.) | MPa | 127 | 124 | 128 | 126 |
| | Bending strength (23° C.) | MPa | 196 | 193 | 198 | 194 |
| | Flexural modulus (23° C.) | MPa | 9200 | 9900 | 9900 | 9900 |
| | Charpy impact strength (23° C., no notch) | KJ/m² | 53 | 53 | 57 | 54 |
| | Weight average fiber length in composition | mm | 0.35 | 0.35 | 0.35 | 0.35 |
| | Aspect ratio of the fibers in composition | — | 35 | 35 | 33 | 33 |
| | Weight average fiber length in molded article | mm | 0.25 | 0.25 | 0.25 | 0.25 |
| | Aspect ratio of fibers in molded article | — | 25 | 25 | 25 | 25 |

Comparison of C-10 (Comparative Example 2) with C-1, C-2, and C-5 (Examples 1, 2, and 5) reveals that a decrease in the amount of low-molecular-weight maleic acid adducts leads to improved physical properties.

### INDUSTRIAL APPLICABILITY

The fiber-reinforced resin composition according to the invention and the molded article produced from the composition can be employed for automobile parts (e.g. front end, fan shroud, cooling fan, engine undercover, engine cover, radiator box, side door, back door inner, back door outer, outer panel, roof rail, door handle, luggage box, wheel cover, handle, cooling module, air cleaner component, air cleaner case, and pedal); parts for bicycles or motorcycles (e.g. luggage box, handle, and wheel); household appliances (e.g. hot water washing toilet sheet, bathroom supplies, chair legs, valves, and meter box); electric tools, handle of a lawn mower, hose joints, resin bolts, and concrete frames. In particular, the fiber-reinforced resin composition and the molded article produced from the composition can be suitably employed for automobile parts including luggage boxes, side doors, air cleaner cases, back door inner, and front-end module (including fan shroud, fan, and cooling module), meter box, switch board, and engine cover.

1. A fiber-reinforced resin composition comprising:
(A) a polyolefin-based resin;
(B) glass fibers having (B1) an average diameter of 3 to 30 μm and (B2) an average aspect ratio of 50 to 6000; and
(C) an acid-modified polypropylene-based resin exhibiting (C1) a change in amount of acid added, measured by Fourier transform infrared spectroscopy, before and after being treated in methyl ethyl ketone at 70° C. for three hours of 0.8 mass % or less, and having (C2) a melt flow rate (load: 2.16 kg, temperature: 230° C.) of 20 to 2000 g/10 min;
the composition containing the components (A) to (C) at such a ratio (mass ratio) that (B):[(A)+(C)]=5 to 80:95 to 20 and (A):(C)=0 to 99.5:100 to 0.5.

2. The fiber-reinforced resin composition according to claim 1, wherein the polyolefin-based resin (A) is a polypropylene-based resin.

3. A molded article produced from the fiber-reinforced resin composition according to claim 1.

4. A molded article produced from the fiber-reinforced resin composition according to claim 2.

5. A maleic acid-modified polypropylene-based resin exhibiting (C1) a change in amount of acid added, measured by Fourier transform infrared spectroscopy, before and after being treated in methyl ethyl ketone at 70° C. for three hours of 0.8 mass % or less, and having (C2) a melt flow rate (load: 2.16 kg, temperature: 230° C.) of 20 to 2000 g/10 min.
